(19) United States
(12) Patent Application Publication
(10) Pub. No.: US 2002/0042735 A1
(43) Pub. Date: Apr. 11, 2002

(54) Parts procuring and managing method, and system therefor

(75) Inventors: Koichi Narahara, Nishinomiya-shi (JP); Hirokazu Kominami, Kakogawa-shi (JP)

Correspondence Address: PARKHURST & WENDEL, L.L.P., 1421 Prince Street, Suite 210, Alexandria, VA, 22314-2805, US

(73) Assignee: MATSUSHITA ELECTRIC INDUSTRIAL CO., LTD.

(21) Appl. No.: 09/985,531

(22) Filed: Nov. 5, 2001

(30) Foreign Application Priority Data
Nov. 6, 2000 (JP) 2000-336797

(51) Int. Cl. G06F 17/60

(52) U.S. Cl. 705/10; 705/28

(57) ABSTRACT

To provide a parts procuring and managing method and a system capable of efficiently achieving an SCM in connection with parts. A client (1), a supplier (2) and a center warehouse (3) are connected together via a network (4). On the basis of the client's obligation for acceptance calculated by the client (1), a forecast-based order is made to the supplier (2) to procure parts. The procured parts are transported to the center warehouse (3) by a freight car (5) and are managed therein.

### FIELD OF THE INVENTION

The present invention relates to a parts procuring and parts managing method executed between a client (or a manufacturer) and a supplier (or a subcontractor of the manufacturer) in the manufacturing industry, when the client makes an order to the supplier for parts to be used in production of products and uses the parts delivered by the supplier, and also relates to a system for the method.

### BACKGROUND OF THE INVENTION

An order maker (hereinafter called “client”) who purchases parts to produce products makes an order for parts to a parts maker or a subcontractor (hereinafter called “supplier”) and performs production using delivered parts. In such a manufacturing industry, much attention is being paid to efforts made for a supply chain management (hereinafter called “SCM”).

The SCM is intended to reduce a lead time required before parts are delivered to a client in response to an order made by the client and to reduce inventories of parts and products. To achieve the SCM, delivery date response mechanism and formulation of production schedules (scheduling system mechanism) corresponding to individual orders made by individual clients have been devised and implemented. Of these efforts, those related to parts significantly affect both the reduction of the lead time and the reduction of the inventories.

For example, the lead time required for parts procurement increases according to the recent tendency of technical advance of parts and integration of parts into a unit, and if the procurement of parts is performed based on each order, the lead time required until the delivery of parts to the client increases in like manner. Thus, to avoid an increase in the lead time, suppliers are notified of middle- or long-term forecast-based orders before actual orders.

Middle- or long-term forecast-based orders are made every week or month, and although the extent of orders affects the lead time required for procurement of parts, parts are ordered the basis of a forecast several months or one year before actual orders. These orders are based on estimation-level production schedules or yearly project schedules.

However, these middle- or long-term forecast-based orders have the following problems.

First, with a middle- or long-term forecast-based order, the amount of parts ordered in itself is not significant. Accordingly, orders based on an estimation-level production schedule or demand prediction or on an annual project schedule invariably cause actual production to deviate in both the quantity in number of parts ordered and the appointed date of delivery. For example, if the production precedes the procurement of parts or the quantity in number of products to be produced increases, there arises a situation where the delivery of ordered parts falls behind with the production, causing deficiency in number of the products produced.

To avoid such a situation, people in charge of procurement at a manufacturer's factory must always monitor the status of production and parts delivery, but if it is impossible to make an order for accelerated delivery, additional orders are required. In this case, since a predetermined procurement lead time is needed, the lead time required before the delivery of parts to the client increases to a great extent. Further, if the quantity in number of parts ordered is larger than the quantity in number of parts required for the actual production, the excessive parts must be stocked.

Consequently, unless the quantity in number of parts ordered based on a forecast equals to the actual required quantity in number, the object of the above SCM cannot be achieved.

### DISCLOSURE OF THE INVENTION

It is an object of the present invention to solve these problems and to provide a parts procuring and managing method and a system therefor, with which the SCM is enabled to be efficiently achieved in connection with parts.

The parts procuring and managing method according to the present invention is characterized in that a center warehouse is provided between a client and a supplier, which are connected together via a network.

According to the present invention, the client and the supplier can share information to reduce the lead time and enable the SCM to be efficiently achieved, thereby reducing the total inventory.

The parts procuring and managing method of the present invention is characterized in that when a client makes an order to a supplier, the client calculates the client's obligation for acceptance for each supplier and each part number, the obligation for acceptance being a quantity in number of parts which the client ensures the supplier of acceptance regardless of any change in the order, based on a total in number of parts of fixed orders and forecast-based orders made by the client to the supplier in the past and a total in number of parts actually delivered up to date, and then makes a forecast-based order to the supplier for procurement of parts.

Preferably, the supplier stores the parts in a center warehouse and the client gives an instruction for delivery to the center warehouse, thereby to deliver the parts from the center warehouse to the client.

The client's obligation for acceptance is calculated by subtracting a total of (hitherto warehoused parts data) from a total of past (fixed order data+forecast-based order data).

If the fixed order data and the forecast-based order data are changed into an increasing direction, the client's obligation for acceptance is calculated by adding an increase in number of parts newly ordered to the client's previous obligation for acceptance and subtracting an increase in number of parts newly warehoused from a result of the addition, and if the fixed order data and the forecast-based order data are changed into a decreasing direction, the client's obligation for acceptance is calculated by subtracting an increase in number of parts actually warehoused from the client's previous obligation for acceptance.

Preferably, upon making a fixed order to the supplier, subsequent forecast-based orders based on a middle- or long-term production schedule and the client's obligation for acceptance are transmitted to the supplier.

Preferably, the number of parts accepted by the center warehouse is limited not to exceed the client's obligation for acceptance for each supplier and each part number.

Specifically, it is preferable that the client and the center warehouse publish information on parts procurement and data on the center warehouse to the supplier via a network to manage data, thereby enabling information sharing and autonomous management at each department.

In addition, a parts procuring and managing system for use in the parts procuring and managing method may be configured so that the client is provided with a first data managing device for executing a parts developing process based on production schedule data and configuration data on finished parts to calculate a quantity in number of parts ordered on the basis of a forecast and the client's obligation for acceptance, and a parts procuring device for transmitting information on parts procurement to the supplier and the center warehouse via the network; the supplier is provided with a second data managing device for obtaining data required for production on the basis of information output from the parts procuring device; and the center warehouse, which receives parts produced by the supplier and ships the parts to the client, is provided with a third data managing device for managing warehousing to restrain the supplier from producing an excess of parts whereby the number of accepted and warehoused parts does not exceed the client's obligation for acceptance for each supplier and each part number, and a warehousing and shipment managing device for managing warehousing and shipment of parts so as to ship parts ordered by the client according to shipment instruction data.

The parts procuring and managing system may also be achieved by providing the first data managing device not at the client but at another location connected to the network.

There may be a plurality of clients, to which parts are delivered from the warehouse, but for simplification, it is assumed in the following example that only one client is involved in the operation. Further, in the following description, parts are managed in the center warehouse, but this inventory is not the client's but the supplier's.

In making an fixed order to the supplier, the client outputs, to the supplier, the client's obligation for acceptance as calculated on the basis of the above-described calculation method and a conventional forecast-based order based on an estimation level production schedule or demand prediction or on a medium- or long-term production schedule such as an annual project schedule, thereby to order parts. Order information includes part type numbers, a quantity in number of parts ordered, and appointed dates of delivery. Further, the quantity in number of parts ordered is the number of parts to be warehoused as indicated to the warehouse and is not the number of parts to be warehoused as indicated to the client.

With the above parts procuring method, the client's obligation for acceptance as presented together with the order information is specifically calculated on the basis of the number of parts of fixed and forecast-based orders made in the past and on the basis of the number of parts actually stored in the center warehouse up to the present time, using the following equation:

the client's obligation for acceptance=(a total of past fixed and forecast-based orders)−(a total of hitherto warehoused parts)

However, with the above parts procuring method, laws such as the subcontract law must be complied with.

That is, for the supplier who falls under the subcontract law, the client's obligation for acceptance must meet the provision under this law, “the number of parts ordered cannot be reduced”. Accordingly, even if the proposed number of parts ordered on the basis of a forecast decreases, the client's obligation for acceptance cannot be reduced by applying the reduced number of parts ordered on the basis of a forecast to the above equation. Consequently, the client must accept an excess of parts.

To avoid forcing the client to accept an excess of parts, on a first forecast-based order for a new period, the client's obligation for acceptance obtained by calculation, excluding an excess at the time, is proposed to the supplier. Then, although the excess of parts are temporarily stored in the center warehouse, the number of parts warehoused will be adjusted because the next client's obligation for acceptance is proposed by treating the excess as an allowance. As a result, the supplier has only to store a designated number of parts in the center warehouse before an appointed date of delivery contained in the order information.

In general, the allowance for the inventory is provided in connection with the order, but in this case, the number of parts required, that is, the production information may be lost. Since is essential in the SCM to share information between the client and the supplier, such loss of information must be avoided. Accordingly, the adjustment with only the client's obligation for acceptance is effective on the SCM.

Thus, according to the parts procuring method of the present invention, the supplier can store parts in the center warehouse before the delivery date designated by the client within the supplier's responsibility. Thus, on the basis of a forecast-based order for several months later, the supplier can efficiently produce parts, and for example, can carry out mass production. Further, the client has proposed the client's obligation for acceptance, so that even with the mass production, there is no possibility that the supplier's stock remains in the warehouse as long as the production is within the supplier's responsibility.

Further, an organization operating the center warehouse can simultaneously manage a plurality of suppliers, thereby getting a scale merit in management. The scale merit may include a reduction in warehouse space costs, system investments, or indirect warehouse operations.

### BRIEF DESCRIPTION OF THE DRAWINGS

FIG. 1 is a schematic view showing a configuration of a parts procuring and managing system according an embodiment of the present invention;

FIG. 2 is a schematic view illustrating an essential part of FIG. 1;

FIG. 3 is a view illustrating a flow of a parts procuring process executed by a client;

FIG. 4 is a view illustrating a flow of production and shipment operations performed by a supplier;

FIG. 5 is a view illustrating a flow of an operation of storing parts in a center warehouse;

FIG. 6 is a view illustrating a flow of an operation performed by the client to instruct the center warehouse to ship parts therefrom; and

FIG. 7 is a view illustrating an example of calculation of the client's obligation for acceptance.

### DESCRIPTION OF THE EMBODIMENTS

A specific embodiment of a parts procuring and managing method according to the present invention will be described below with reference to the drawings.

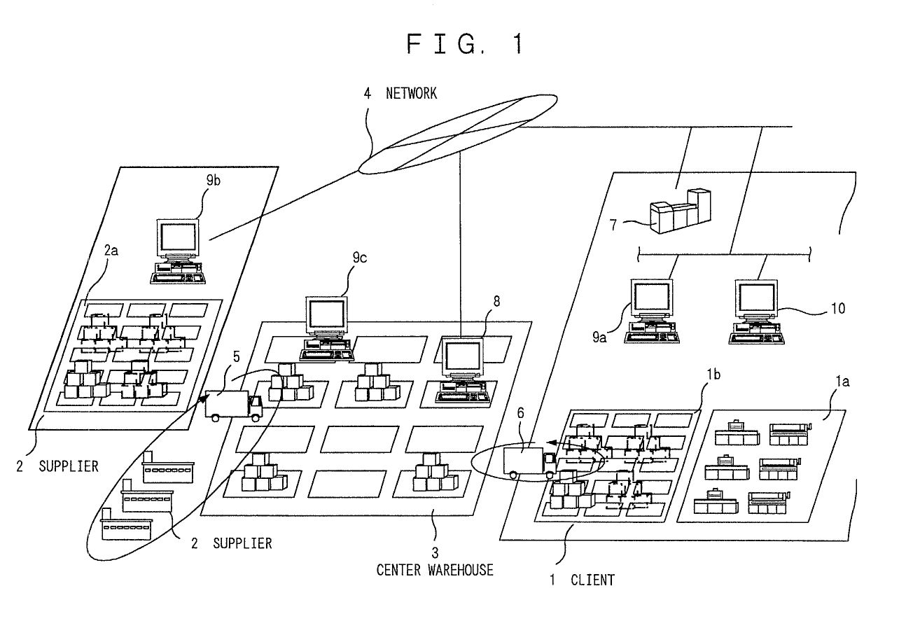

FIG. 1 shows a network system as an system for implementing the parts procuring and managing method of the present invention.

A center warehouse 3 in the form of a cooperative warehouse for a plurality of suppliers is located between a client 1 and a supplier 2. The client 1 and the supplier 2 and the warehouse 3 are connected together via a network 4 so as to be able to share information on procurement and management of parts. A specific example of the network 4 is the Internet, for example.

The client 1 is specifically a factory having a parts procuring system 7 for transmitting a forecast-based order determined by executing a parts developing process on production schedule data or configuration data on finished parts and the client's obligation for acceptance, to the supplier 2 and the center warehouse 3 via the network 4, as well as a first data managing device 9a for managing data at the client 1. Reference numeral 1a denotes a production facility, 1b is parts warehouse, and 10 is a production schedule creating device.

The supplier 2 has a second data managing device 9b for managing the production of parts on the basis of information output from the parts procuring device 7 of the client 1. In actuality, a plurality of suppliers 2 are present, but for explanation, one company is described by way of example. Reference numeral 2a denotes the supplier 2's finished parts warehouse.

The center warehouse 3, which receives parts produced and transported by the supplier 2 and delivers them to the client 1, is provided with a third data managing device 9c so as to limit accepted parts to the client's obligation for acceptance for each supplier and part number, thereby restraining the supplier 2 from producing an excess of parts, as well as a warehousing and shipment managing device 8 for managing warehousing and shipment of parts so as to deliver parts requested by the client 1 according to shipment instruction data.

Reference numeral 5 denotes a freight car as a transportation means for running around the suppliers 2 to load and collect various parts therein, and reference numeral 6 denotes a freight car as a transportation means for delivering parts from the center warehouse 3 to the client 1.

The forecast-based order and the client's obligation for acceptance created by the client 1's parts procuring device 7 are transmitted to the client 1 and the center warehouse 3 via the network 4. The supplier 2 then produce parts based on the transmitted information.

Parts completed by the supplier 2 are temporarily stored in the finished parts warehouse 2a of the supplier 2, and are periodically transported to the center warehouse 3.

The warehousing and shipment managing device 8 of the center warehouse 3 is responsible for a warehousing process and a shipment process. The warehousing process is executed for storing loaded data on warehousing from the supplier 2 and locations in the center warehouse 3 where parts are stored so that the data and the locations are associated with each other. The shipment process such as a picking operation is executed for picking up only parts ordered by the client from the stored locations on the basis of a shipment instruction transmitted from the parts procuring device 7 to the warehousing and shipment managing device 8 on the basis of actual production at the client 1.

Parts picked up from the center warehouse 3 are transported to the parts warehouse 1b by the freight car 6 and stored therein for a fixed period before the actual production. The warehoused parts are consumed immediately, specifically, when the production facility 1a makes a corresponding request after a short period of storage in the parts warehouse 1b.

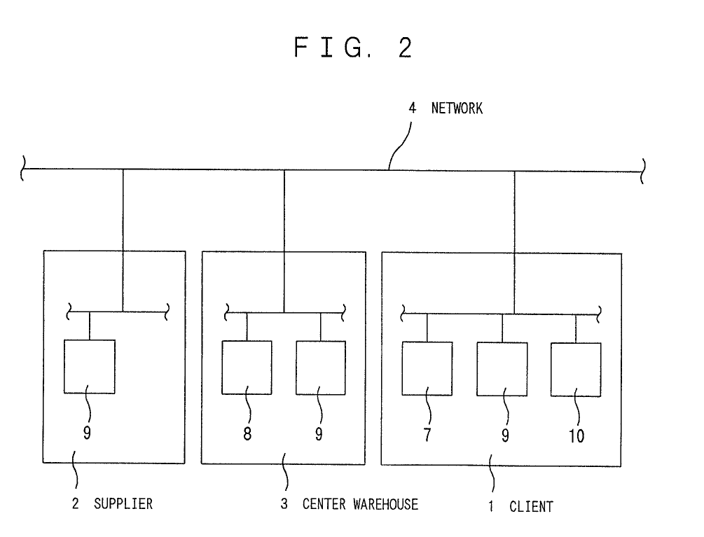

Thus, with the parts procuring and managing system of the present invention, the client (factory) land the supplier 2 and the center warehouse 3 are connected together via the network 4 as shown in FIG. 2. Accordingly, data can be shared by the processing devices distributed at different locations to minimize the size of the client's inventory, thereby allowing the supplier 2 to efficiently produce parts.

The client 1, the supplier 2, and the center warehouse 3 may be different organizations or corporations. In this case, in general, if they are different organizations, data communication may be sparse, but the connections via the network 4 enables them to function as a single organization.

The system will be described in more detail.

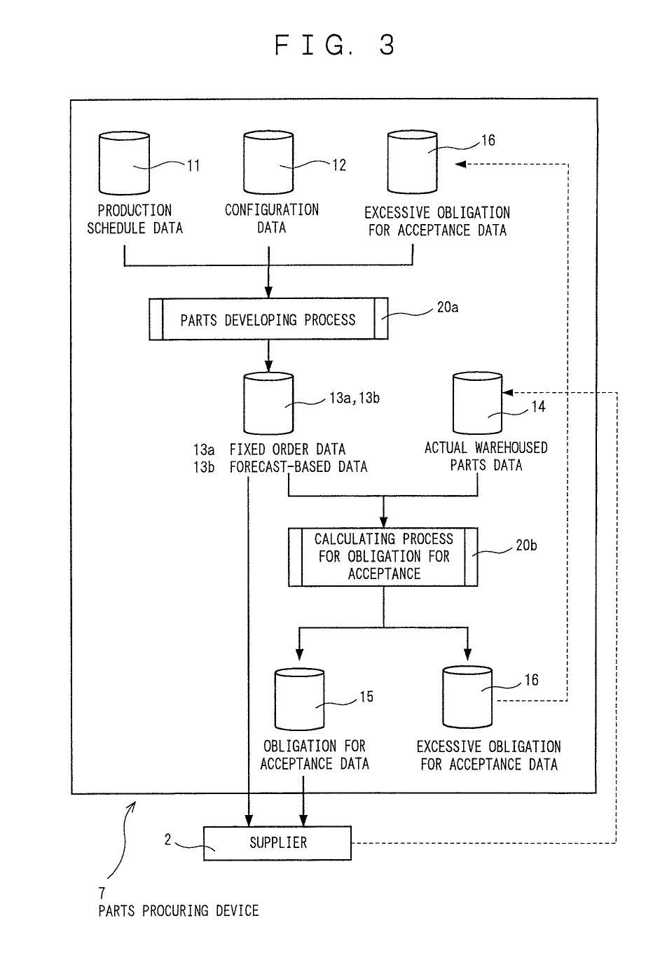

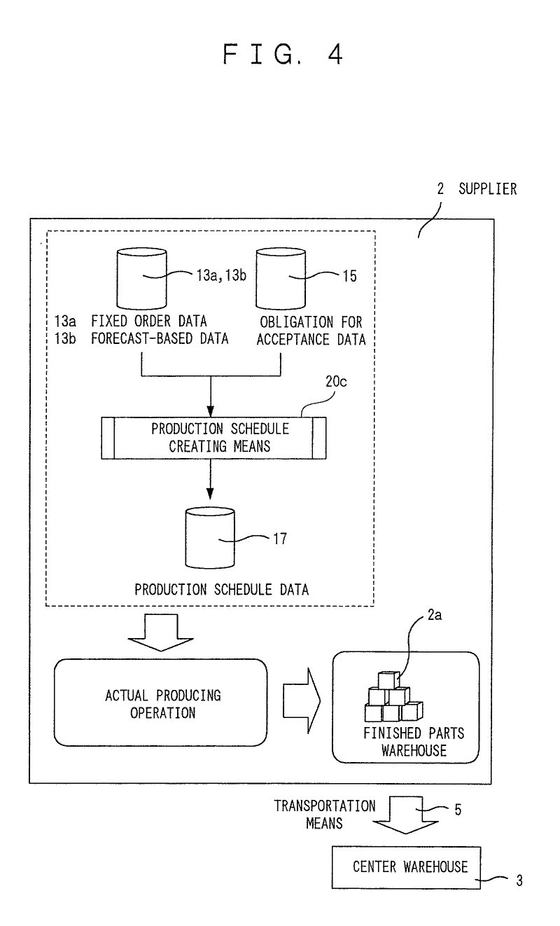

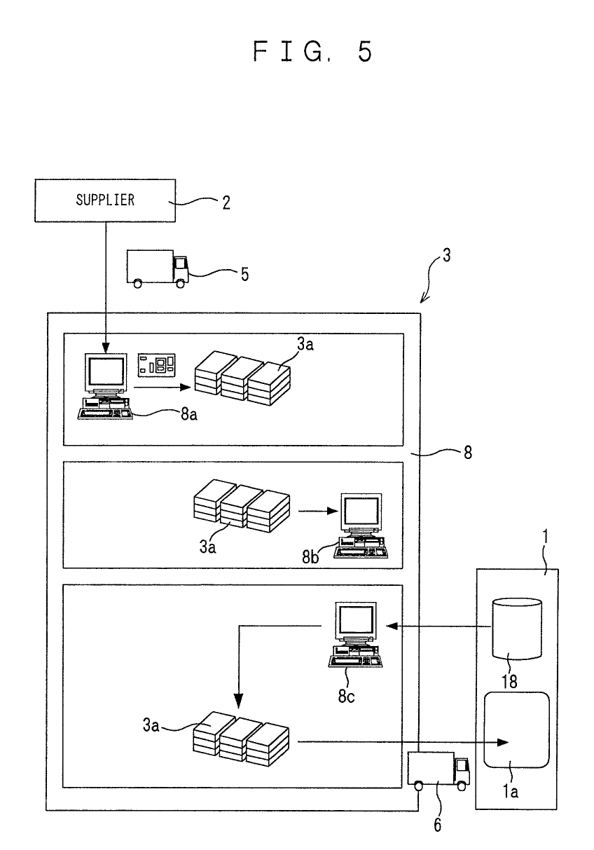

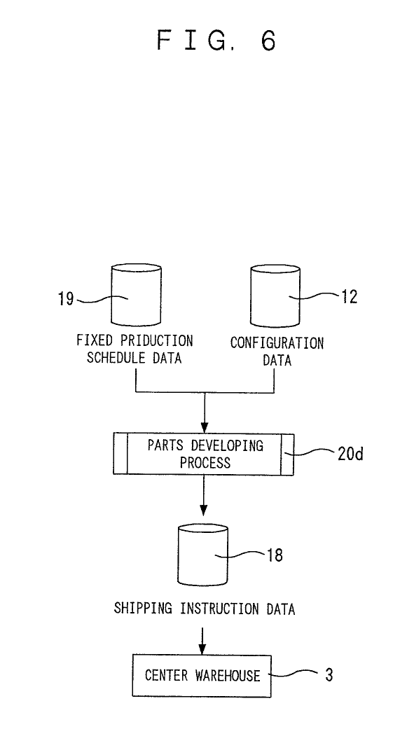

FIG. 3 shows the flow of a process from the client 1 to the supplier 2. FIG. 4 shows the flow of an operation of transporting parts to the supplier 2 and the center warehouse 3. FIG. 5 shows the flow of an operation of storing parts in the center warehouse 3. FIG. 6 shows the flow of an operation performed by the client to instruct the center warehouse 3 to ship parts therefrom.

The parts procuring device 7 of the client 1 orders parts to the supplier 2 by calculating the clients obligation for acceptance for each supplier and part number on the basis of the total number of parts previously ordered to the supplier 2 decisively and on the basis of a forecast as well as the number of parts delivered up to the present time, and then making a forecast-based order to the supplier 2 to procure parts.

The client 1 calculates the client's obligation for acceptance for each supplier and part number according to the process flow shown in FIG. 3 using the first data managing device 9a.

The parts procuring device 7 incorporates production schedule data 11 indicative of a production schedule such as an estimated production schedule, a demand prediction, or an annual project schedule, configuration data 12 as registered relations between finished parts at the client 1 and their components, and excessive obligation for acceptance data 16, described later. A parts developing process 20a is executed by a method such as MRP (Material Requirement Planning) using the production schedule data 11, the configuration data 12, and the excessive obligation for acceptance data 16.

In the parts developing process 20a, fixed order data 13a and forecast-based order data 13b are created on the basis of the production schedule data 11 and the configuration data 12, with the resultant data output to the supplier 2.

Further, an obligation for acceptance calculating process 20b is executed on the basis of the fixed order data 13a and the forecast-based order data 13b as well as warehousing results data 14 based on 60th data 13a and 13b which is stored in the center warehouse 3 by the supplier 2.

In the obligation for acceptance calculating process 20b, the obligation for acceptance data 15 is calculated on the basis of a difference between the totals of the fixed order data 13a and forecast-based order data 13b as shown in Equation 1, and the excessive obligation for acceptance data 16, described later, is calculated.

The client's obligation for acceptance=a total of past (fixed order data 13a+forecast-based order data 13b)−(a total of the hitherto warehousing result data 14) [Equation 1]

However, if the production schedule data 11 for the same period is changed and the fixed order data 13a and the forecast-based order data 13b are thus changed, then the calculation of the obligation for acceptance data 15 requires the following correcting process.

First, if the fixed order data 13a and the forecast-based order data 13a change in an increasing direction, the client's obligation for acceptance is calculated by adding the number of parts newly ordered to the client's previous obligation for acceptance and then subtracting the number of parts newly stored from the result of the addition as shown in Equation 2.

The client's obligation for acceptance=(client's previous obligation for acceptance)+(number of parts newly ordered)−(total number of parts newly stored) [Equation 2]

On the other hand, if the fixed order data 13a and the forecast-based order data 13b change in a decreasing direction, the client's obligation for acceptance is calculated by subtracting the number of parts newly stored from the client's previous obligation for acceptance as shown in Equation 3.

the client's obligation for acceptance=(client's previous obligation for acceptance)−(number of parts newly stored) [Equation 3]

If the fixed order data 13a and the forecast-based order data 13a change in a decreasing direction, the decrease is calculated as the client's excessive obligation for acceptance. The client's excessive obligation for acceptance as calculated is retained as the excessive obligation for acceptance data 16.

In calculating the client's next obligation for acceptance, the client's excessive obligation for acceptance is offset by the increase in Equation 2.

The client's obligation for acceptance=(client's previous obligation for acceptance)+(number of parts newly ordered)−(total number of parts newly stored)−(client's excessive obligation for acceptance) [Equation 4]

However, if the result of the (number of parts newly ordered)−the (client's excessive obligation for acceptance) is negative, the client's obligation for acceptance is calculated using Equation 5.

The client's obligation for acceptance=(client's previous obligation for acceptance)−(client's excessive obligation for acceptance) [Equation 5]

In this case, the client's excessive obligation for acceptance is as shown in Equation 6.

The client's excessive obligation for acceptance=(client's previous obligation for acceptance)−(number of parts newly ordered) [Equation 6]

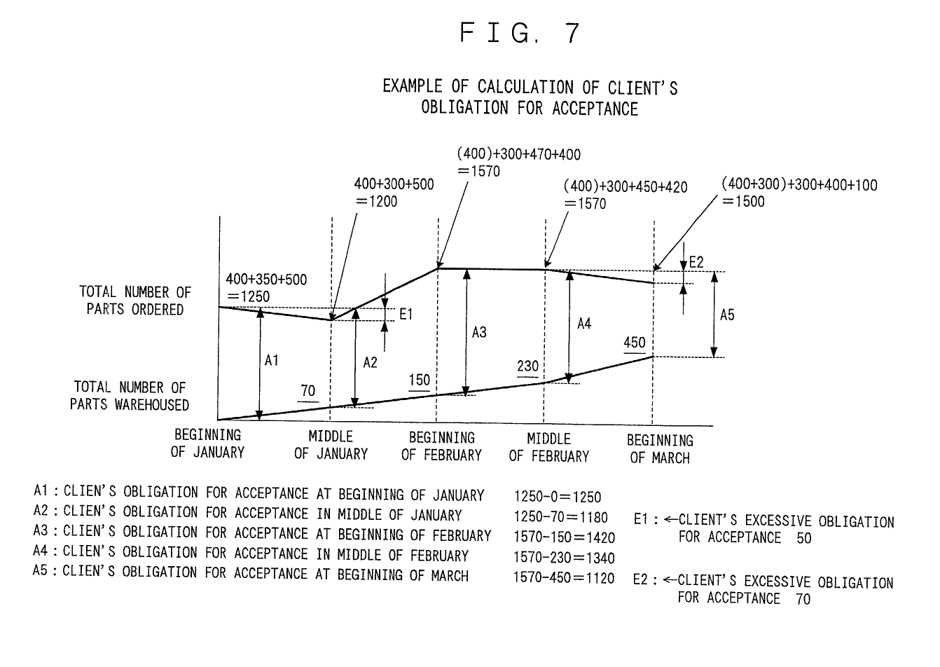

An example of the client's obligation for acceptance will be described with reference to FIG. 7.

Starting at the beginning of January, procurement of certain parts is carried out in the following manner:

February: 400 parts (fixed order)

March: 350 parts (forecast-based order)

April: 500 parts (forecast-based order)

The total number of parts warehoused is zero because the procurement has just been started. At this point, the client's obligation for acceptance A1 is:

The client's obligation for acceptance=(400+350+500)−0=1250.

In the middle of January, the forecast-based orders are modified as follows:

February: 400 parts (fixed order)

March: 300 parts (forecast-based order); a decrease of 50 parts

April: 500 parts (forecast-based order)

In the example shown in FIG. 7, the number of parts stored at this point is 70. At this point, the client's obligation for acceptance A2 is:

The client's obligation for acceptance=1250−70=1180.

The client's excessive obligation for acceptance E1 is 50 parts.

At the beginning of February, procurement for a new period is carried out in the following manner:

March: 300 parts (fixed order)

April: 470 parts (forecast-based order); a decrease of 30 parts

May: 400 parts (forecast-based order); an increase of 400 parts (new)

In the example shown in FIG. 7, the number of parts warehoused at this point is 150 parts.

The total increase or decrease in the number of parts ordered=400 −30=370

The total increase in the number of parts warehoused=150−70=80

The client's obligation for acceptance A3=1180−80+370−50=1420

The client's excessive obligation for acceptance=0

At this point, the client's excessive obligation for acceptance, which occurred in the middle of January, is offset.

In the middle of February, the forecast-based orders are modified in the following manner:

March: 300 parts (fixed order)

April: 450 parts (forecast-based order); a decrease of 20 parts

May: 420 parts (forecast-based order); an increase of 20 parts

In the example shown in FIG. 7, the number of parts warehoused at this point is 230 parts.

The total increase or decrease in the number of parts ordered=20−20=0

The total increase in the number of parts warehoused=230−150=80

The client's obligation for acceptance A4=1420−80=1340

The delivery of the twenty parts is postponed, but the client's excessive obligation for acceptance does not occur.

At the beginning of March, procurement for a new period is carried out.

April: 300 parts (fixed order); a decrease of 150 parts May: 400 parts (forecast-based order); a decrease of 20 parts

June: 100 parts (forecast-based order); an increase of 100 parts (new)

In the example shown in FIG. 7, the number of parts warehoused at this point is 450 parts.

The total increase or decrease in the number of parts ordered=100−150−20=70

The total increase in the number of parts warehoused=450−230=220

The client's obligation for acceptance A5=1340−220=1120

The client's excessive obligation for acceptance E2=0−(−70)=70

A drastic decrease occurs in April and May, but this does not affect the client's obligation for acceptance.

As apparent from the above example, in contrast to conventional procuring methods using ordering slips, the present method is flexible in dealing with changes in the appointed date of delivery because the procurement is managed using only the client's obligation for acceptance. Further, even if the client's excessive obligation for acceptance occurs, it can be offset during the next new order. However, if the client's excessive obligation for acceptance is very large, it may not be offset with a single procurement. In such case, it will be offset using a plurality of subsequent procurements.

Thus, the client's already proposed obligation for acceptance can be always guaranteed for the supplier 2 by accommodating a decrease in the number of parts ordered on the basis of the client's excessive obligation for acceptance by leaving the obligation for acceptance as it is in such a way that the client's excessive obligation for acceptance is allowed for in proposing the client's obligation for acceptance. Further, the client 1 can autonomously create a production schedule within the range of the proposed delivery date and quantity in number of parts, and can enhance the efficiency of production.

The above obligation for acceptance calculating method is essential in achieving a parts procuring method that ensures that the client accepts all produced parts. Further, the excessive forecast-based order, resulting from the proposal of the client's obligation for acceptance without any reduction, is allowed for at the time of the next proposal of the client's obligation for acceptance, thereby precluding an excess of parts from being stored in the center warehouse 3 over a long time.

Next, when parts are to be procured on the basis of the client's calculated obligation for acceptance, referential information is transmitted to the supplier 2, including fixed orders and subsequent forecast-based orders based on a middle- or long-term production schedule as well as the client's obligation for acceptance, as shown in FIG. 4.

On the basis of the fixed order data 13a, forecast-based order data 13b and obligation for acceptance data 15 output by the client 1, the second data managing device 9b of the supplier 2 creates production schedule data 17 in a production schedule creating means 20c.

Based on this production schedule data 17, the supplier 2 starts actual production activities.

Finished parts are stored in the finished parts warehouse of the supplier 2. Reference numeral 2a denotes a stock of the supplier 2's finished parts present in the finished parts warehouse.

The stock of finished parts 2a are transported to the center warehouse 3 by the freight car 5, which periodically runs around the suppliers to load and collect parts. Consequently, the stock of finished parts 2a is always maintained at a fixed number or less.

FIG. 5 shows a process executed by the warehousing and shipment managing device 8 for managing warehousing and shipment of parts in and from the center warehouse 3.

Finished parts stored in the center warehouse 3 is processed by the warehousing and shipment managing device 8, comprising a warehousing processing device 8a, an inventory processing device 8b, and a shipment processing device 8c. Reference numeral 3a denotes a stock of parts in the center warehouse 3, and reference numeral 18 denotes a shipment instruction data from the client 1.

The warehousing processing device 8a subjects parts loaded and collected by the freight car 5, which periodically runs around the suppliers 2, to a warehousing process and specifically to a check on the supplier 2 and part number and a check for a deviation from the client's obligation for acceptance.

Parts with a supplier 2 and a part number that are not registered in the above-described configuration data 12 are rejected via the third data managing device 9c. Warehousing of parts that may lead to an excess over the client's obligation for acceptance recorded in the obligation for acceptance data 15 for each supplier and part number is also rejected. The warehoused parts have their shelf numbers managed in the center warehouse 3.

Specifically, the third data managing device 9c manages warehousing so as to hinder the center warehouse 3 from accepting warehousing of parts that may lead to an excess over the client's obligation for acceptance for the corresponding supplier and part number. As a result, the supplier is restrained from producing an excess of parts.

The stock of parts 3a having their shelf numbers managed in the center warehouse 3 are periodically inventoried by the inventory processing device 8b to correct the stock.

The shipment instruction data 18 is transmitted from the client 1 to the shipment processing device 8 via the network 4. The warehousing and shipment managing device 8 then gives a stock picking instruction, on the basis of which a picking operation is performed. The picking operation may be performed manually or by a machine such as an automatic rack.

The picked-up parts are shipped from the center warehouse 3 by the transportation means 6, which delivers the parts from the center warehouse 3 to the client 1.

FIG. 6 shows the flow of an operation performed by the client 1 to instruct the center warehouse 3 to ship parts therefrom.

Established order data 19 is created by the production schedule creating device 10 or manually at the managing section of the client 1.

The fixed order data 19 and the configuration data 12 are used to execute the parts developing process 20d to create the shipment instruction data 18. The shipment instruction data 18 is created using a conventional method such as the MRP.

With such a parts procuring and managing method, the client 1 calculates its obligation for acceptance for each supplier and part number on the basis of the total number of parts ordered decisively and on the basis of a forecast and the total number of parts delivered up to the present time, and makes a forecast-based order to the client 1 to procure parts, thereby maximizing a cash flow to improve productivity.

In the above embodiment, the client 1 is provided with the first data managing device 9a, which calculates the total number of parts ordered based on a forecast and the client's obligation for acceptance by executing the parts developing process on the basis of the production schedule data and the configuration data for finished parts. However, rather than being provided at the client 1, the first data managing device 9a may be provided at a location connected to the network 4 so that the single data managing device 9a can comprehensively manage the data processing in a plurality of clients 1.

As described above, according to the parts procuring and managing method of the present invention, when the client makes an order to the supplier, the client calculates the client's obligation for acceptance for each supplier and part number, the quantity in number of parts, based on the total of the number of parts previously ordered to the supplier decisively and on the basis of a forecast and on the number of parts delivered up to the present time, and then makes a forecast-based order to the supplier to procure parts. Further, if fixed order information, subsequent forecast-based orders based on a middle- or long-term production schedule, and the client's obligation for acceptance are transmitted to the supplier without making a fixed order to the supplier, the supplier can carry out production before the fixed order within the range of its responsibility without causing its stock to remain in the warehouse because the client's obligation for acceptance is specified. Consequently, mass production is possible, thereby increasing productivity.

Further, the supplier is restrained from producing an excess of parts by limiting the number of parts accepted by the center warehouse to the client's obligation for acceptance for each supplier and part number.

Furthermore, the client and the center warehouse publishes information on parts procurement and data on the center warehouse to the supplier via the network to manage data, thereby allowing information to be shared over the network to minimize the needs for reporting operations performed by the supplier and the factory.

Moreover, the present invention provides a parts procuring and managing system that connects a client and a supplier and a center warehouse together via a network, wherein the client is provided with a parts procuring device for executing a parts developing process on the basis of production schedule data and configuration data on finished parts to determine the number of parts ordered decisively and on the basis of a forecast the client's obligation for acceptance, and transmitting the information to the supplier and the center warehouse via the network, and a first data managing device for managing data at the supplier, and the supplier is provided with a second data managing device for obtaining data required for production on the basis of information output by the parts procuring device, and the center warehouse, to which parts produced by the supplier are transported and ships the parts to the client, is provided with a parts warehousing and shipment managing device for managing warehousing and shipment of parts from the supplier, and a third data managing device for managing data at the center warehouse. Then, a fourth data managing device for unifying these data managing devices is provided at a location connected to the network. Consequently, few of the factory's stocks remain at the supplier, and the number of parts produced substantially equals the number of parts stored in the center warehouse, thereby allowing the status of the supplier's production to be determined. Further, rather than being distributed to the supplier and the factory, all the parts are stored in the center warehouse, thereby enabling the stock of parts to undergo gross management. Furthermore, the factory can give a shipment instruction to the center warehouse according to the latest production status. Accordingly, since the factory has only to have a minimum amount of stocks, required stock managing spaces and operations can be reduced to make the business very efficient and eventually reduce the costs of products. Moreover, information on the stocks in the center warehouses and on a future production schedule can be shared between the factory and the supplier, thereby enabling possible defects in parts to be determined beforehand so as to take action to avoid them. This in turn avoids the delay of production resulting from such defects in parts and enables parts to be delivered before the appointed date of delivery.

Thus, according to the parts procuring and managing method, the client gives a shipment instruction to the center warehouse depending on the status of production to cause the center warehouse to deliver parts. First, once a production schedule is decided, MRP (Material Requirement Planning) is carried out and a shipment instruction is given to the center warehouse on the basis of this plan. Then, on the basis of this shipment instruction, parts are delivered to the client in a JIT (Just In Time: required amounts of required parts are supplied at required times) manner in connection with to the production, and the stocks of parts can be limited to a minimum required amount. Further, since the required amount of stocks substantially decreases, required stock storage spaces and stock managing operations can be reduced. Furthermore, even if the production schedule is unexpectedly changed or an unexpected additional amount of parts are ordered, parts can be delivered from the center warehoused without the need to make an order to the supplier as long as there is a proper stock in the center warehouse.

Such a parts shipment instructing method serves to minimize the client's inventories and avoid the possible shortage of parts to be delivered. Further, since the client, the supplier, and the center warehouse are connected together via the network, the client and the center warehouse can publish information on procurement and data on the center warehoused to the supplier via the network.

According to data managing method, the management of parts in the center warehouse is similar to common warehousing, shipment, and inventory management. However, data on the center warehouse such as the number of parts warehoused or shipped, the current amount of stocks, and the client's current obligation for acceptance can be published to the supplier and the client, thereby enabling information to be shared and allowing each department to carry out autonomous management. Further, reporting operations are important to warehouse management, and this data managing method serves to reduce these operations.

Therefore, the present invention achieves the maximization of a cash flow and customers' satisfaction, which is the object of the SCM.

1. A parts procuring and managing method, wherein
when a client makes an order to a supplier,
the client calculates the client's obligation for acceptance for each supplier and each part number, the obligation for acceptance being a quantity in number of parts which the client ensures the supplier of acceptance regardless of any change in the order, based on a total in number of parts of fixed orders and forecast-based orders made by the client to the supplier in the past and a total in number of parts actually delivered up to date, and then makes a forecast-based order to the supplier for procurement of parts.

2. A parts procuring and managing method, wherein
when a client is to procure parts required for production,
the client calculates the client's obligation for acceptance for each supplier and each part number, the obligation for acceptance being a quantity in number of parts which the client ensures the supplier of acceptance regardless of any change in the order, based on a total in number of parts of fixed orders and forecast-based orders made by the client to the supplier in the past and a total in number of parts actually delivered up to date, thereby to make a forecast-based order to the supplier,
the supplier stores the parts in a center warehouse, and
the client gives an instruction for delivery to the center warehouse, thereby to deliver the parts from the center warehouse to the client.

3. The parts procuring and managing method according to claim 1 or 2, wherein the client's obligation for acceptance is calculated by subtracting a total of (hitherto warehoused parts data) from a total of past (fixed order data+forecast-based order data).

4. The parts procuring and managing method according to claim 1 or 2, wherein if the fixed order data and the forecast-based order data are changed into an increasing direction, the client's obligation for acceptance is calculated by adding an increase in number of parts newly ordered to the client's previous obligation for acceptance and subtracting an increase in number of parts actually warehoused from a result of the addition, and
if the fixed order data and the forecast-based order data are changed into a decreasing direction, the client's obligation for acceptance is calculated by subtracting an increase in number of parts actually warehoused from the client's previous obligation for acceptance.

5. The parts procuring and managing method according to claim 1 or 2, wherein upon making a fixed order to the supplier, subsequent forecast-based orders based on a middle- or long-term production schedule and the client 's obligation for acceptance are transmitted to the supplier.

6. The parts procuring and managing method according to claim 2, wherein the supplier is restrained from producing an excess of parts by limiting the number of parts accepted by the center warehouse not to exceed the client's obligation for acceptance for each supplier and each part number.

7. The parts procuring and managing method according to claim 2, wherein the client and the center warehouse publish information on parts procurement and data on the center warehouse to the supplier via a network so as to manage data, thereby performing information sharing and autonomous management at each department.

8. A parts procuring and managing system that connects a client, a supplier and a center warehouse via a network, wherein
the client is provided with:
a first data managing device for executing a parts developing process based on production schedule data and configuration data on finished parts so as to calculate a quantity in number of parts ordered on a basis of a forecast and an obligation for acceptance by the client; and
a parts procuring device for transmitting information on parts procurement to the supplier and the center warehouse via the network,
the supplier is provided with:
a second data managing device for obtaining data required for production of parts on the basis of information output from the parts procuring device, and
the center warehouse, which receives parts produced by the supplier and ships the parts to the client, is provided with:
a third data managing device for restraining the supplier from producing an excess of parts by controlling warehousing so that the number of accepted and warehoused parts does not exceed the client's obligation for acceptance for each supplier and each part number; and
a warehousing and shipment managing device for managing warehousing and shipment of parts so as to ship parts requested by the client according to shipment instruction data.

9. The parts procuring and managing system according to claim 8, wherein the first data managing device is not provided for the client but is provided at another location connected to the network.
